(19) United States
(12) Patent Application Publication
(10) Pub. No.: US 2006/0112799 A1
(43) Pub. Date: Jun. 1, 2006

(54) Fiber cement saw blade

(76) Inventors: Neal S. Hambleton, Huntersville, NC (US); Martin Murphy, North Shore City (NZ); Matthew Gillanders, Wellsford (NZ); Craig David McGregor, Kaipara Flats (NZ)

Correspondence Address: MOORE & VAN ALLEN PLLC, P.O. BOX 13706, Research Triangle Park, NC, 27709, US

(21) Appl. No.: 11/000,118

(22) Filed: Nov. 30, 2004

(51) Int. Cl. B23D 57/00

(52) U.S. Cl. 83/13; 83/835; 76/25.1

(57) ABSTRACT

The saw blade includes a plate supporting a plurality of teeth about the periphery thereof. Each tooth consists of a cutting tip supported in a tip pocket. The tips are brazed to the tip pockets with no side clearance taper created on the tips. The side faces on the tips are parallel to each other. The tip pockets are stamped into the blade using a high volume stamping process that employs a semi-circular relief at the proximate trailing corner of the tip pocket to receive the proximate trailing corner of the cutting tip. The relief can be formed in a high volume stamping process because it eliminates the need for a sharp corner. The relief accommodates the sharp edge of the cutting tip and allows the cutting tip to be properly seated on the tip pocket for connection thereto.

### BACKGROUND OF THE INVENTION

The invention relates generally to saw blades and more particularly to an improved rotary saw blade for fiber cement.

Rotary saw blades typically consist of a plurality of teeth extending generally radially from the periphery of a metal plate. An arbor hole is formed in the center of the plate to attach the blade to the arbor of a rotary tool such as a table saw, circular saw or the like such that the blade can be rotated by the rotary tool. One typical fiber cement blade includes a plurality of teeth arranged about the periphery thereof. The teeth consist of polycrystalline diamond (PCD) cutting tips brazed into tip pockets, i.e. the area of the plate in which the tips are secured, formed about the periphery of the blade. The manufacturing process of PCD entails industrial grade diamond sintered onto a carbide disk under high temperature and pressure. The tips are cut from the flat disk using a wire EDM (electrical discharge machining). The EDM process creates tips with sharp edges and parallel opposing side surfaces. In order to be able to braze the tips onto the tip pockets it is important that the tip pockets closely engage the surfaces of the cutting tips. The tip pockets formed in the blade, therefore, have been formed with sharp comers that mate with the sharp edges of the PCD tips. In order to obtain the sharp edges for the tip pockets, the tip pockets are cut into the blade using a laser.

Until now it was thought necessary to provide a clearance taper on the cutting tips of fiber cement saw blades to create a clearance to allow the blade to move through the material. To create the typical clearance taper, the opposing side faces and/or top face of the cutting tips are shaped in a separate process after the tips are cut from the PCD material. The faces are dimensioned so as to narrow or taper from the tip's leading face to the tip's trailing face. The narrowing width of the face from front to back is the clearance taper. In the typical process, the opposing side faces, and/or the top face, of the tips are ground in a grinding process after the tips are secured in the tip pockets to create the clearance taper.

The process to create the clearance taper and the laser cutting of the tip pockets increases the cost of manufacture of existing fiber cement saw blades and requires multiple manufacturing processes.

Thus, improved fiber cement saw blade that is less costly to manufacture is desired.

### SUMMARY OF THE INVENTION

In one embodiment of the invention, the saw blade of the invention includes a plate supporting a plurality of teeth about the periphery thereof. Each tooth consists of a cutting tip supported in a tip pocket. The tips, after being cut using the EDM process, are brazed to the tip pocket and no clearance taper is created on the tips. Because the tips do not use a clearance taper, the tip grinding process is eliminated from the blade manufacturing process reducing the cost of manufacture of the saw blade.

Moreover, the tip pockets are stamped into the blade using a high volume stamping process that employs a semi-circular relief at the proximate trailing corner of the tip pocket to receive the proximate trailing corner of the cutting tip. The relief can be formed in a high volume stamping process because it eliminates the need for a sharp corner. The relief accommodates the sharp edge of the cutting tip and allows the cutting tip to be properly seated on the tip pocket for connection thereto. The use of a stamping process to form the tip pocket also reduces the manufacturing cost because the stamping process is less expensive than a laser cutting process.

The elimination of the grinding process on the cutting tips and the use of a stamping process to form the tip pocket reduce the cost of manufacturing the saw blade of the invention. Moreover, the use of the relief increases the life of the blade because it eliminates the sharp corner previously used in tip pocket that creates high stress areas that are prone to failure.

### BRIEF DESCRIPTION OF THE DRAWINGS

FIG. 1 is a side view of an embodiment of the saw blade of the invention.

FIG. 2 is a partial side view of the opposite side of the saw blade of FIG. 1.

FIG. 3 is a partial side view of the saw blade similar to that of FIG. 2 with the cutting tip removed.

FIG. 4 is a side view of a cutting tip used in the saw blade of the invention.

FIG. 5 is a bottom view of a cutting tip used in the saw blade of the invention.

FIG. 6 is a block diagram of a method of making the saw blade of the invention.

### DETAILED DESCRIPTION OF VARIOUS EMBODIMENTS OF THE INVENTION

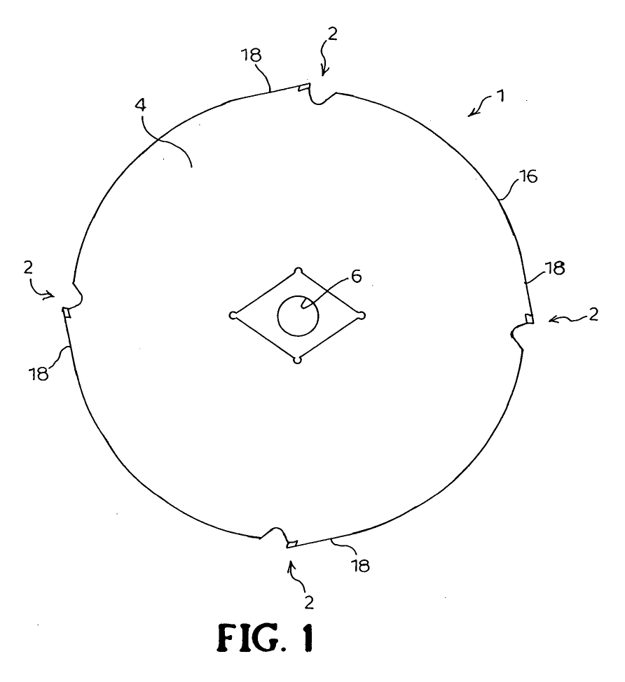

FIG. 1 shows a side view of an embodiment of the saw blade 1 of the invention. Blade 1 has four teeth 2 arranged about the periphery of plate 4. Plate 4 is a planar substantially circular piece of rigid material such as steel having opposed parallel sides 4a. It is to be understood that the invention can be used with a saw blade having any number of teeth and that the four tooth blade is used by way of example only. A hole 6 is centrally located in plate 4 to attach the saw blade to the arbor of a rotary tool such as a circular saw, table saw, powered miter saw or the like in a known manner to rotate the blade in the direction of arrow A (not sure where this is on the drawing?) as is known in the art. The blade of the invention is particularly suited for cutting fiber board such sold under the HARDIPLANK, HARDIPANEL, DUROCK, CEMPLANK, CERTAINTEED and NICHIHA trademarks and other similar material. Fiber cement is a compressed matrix bonding of fiber cement.

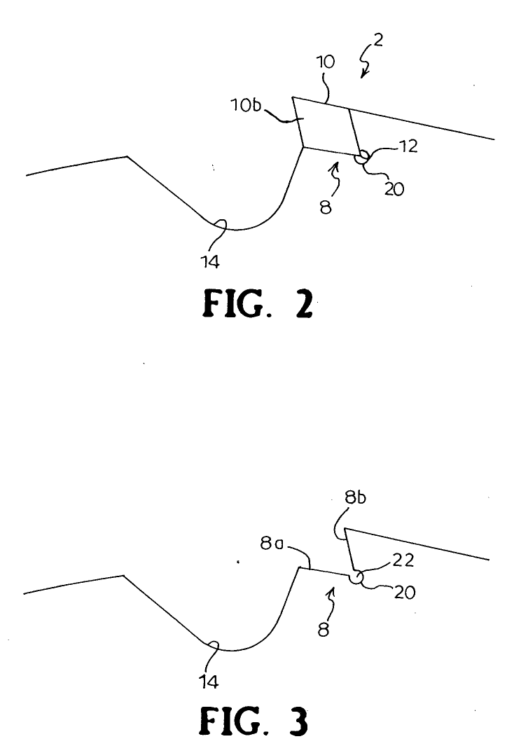

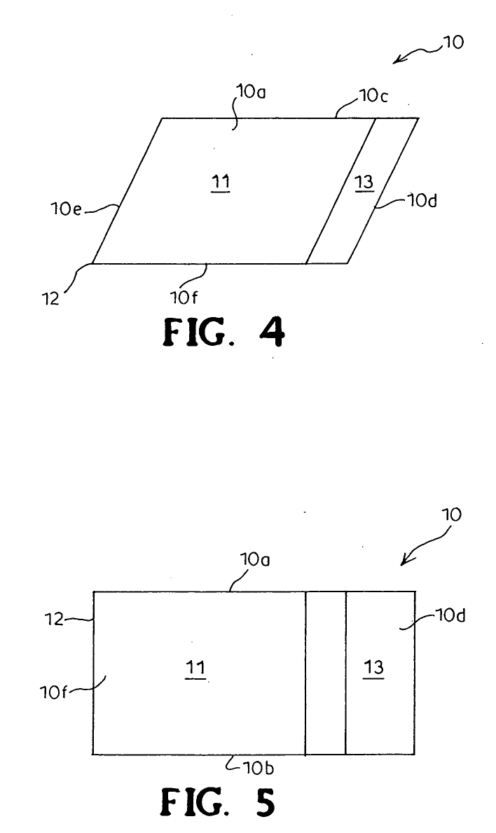

Referring to FIGS. 2 and 3, each tooth 2 consists of a tip pocket 8 supporting a cutting tip 10. A gullet 14 is formed adjacent to the leading face of tips 10 to facilitate the removal of cut material from the cut. Referring also to FIGS. 4 and 5, cutting tip 10 is made of PCD material and has a carbide base portion 11. The PCD material is cut to create a cutting tip having opposed side faces 10a and 10b, top face 10c, leading face 10d, trailing face 10e and bottom face 10f. Bottom face 10f and trailing face 10e meet at an acute angle to create a sharp proximate trailing edge 12. Moreover, the opposed side faces 10a and 10b and the opposed top face 10c and bottom face 10f are disposed parallel to one another after the EDM cutting operation. Cutting tip 10 is dimensioned such that opposed side surfaces extend beyond the surfaces of plate 4. Significantly, the inventors have discovered that cutting tips having parallel opposed side faces 10a and 10b, that are also parallel to the side surfaces of plate 4, cut fiber cement similar to cutting tips having clearance tapered side and or top faces. Thus, the tips do not require any clearance taper shaping or processing, such as grinding, after they are cut from the PCD material. The manufacture of the blade of the invention eliminates an entire processing step used in the manufacture of known fiber cement blades thereby significantly reducing the manufacturing cost of the blade. Moreover the tips can be cut from stacks of PCD disks producing larger quantities of cutting tips in a single cutting process.

The tips pocket 8 of the blade of the invention are best shown in FIG. 3 and include a first face 8a and a second face 8b. Faces 8a and 8b are arranged to receive and closely support the bottom face 10f and trailing face 10e of cutting tips 10. It is important that the faces 8a and 8b closely support the bottom and back faces of the cutting tips to provide structural support for the cutting tips and to provide mating surfaces to allow the brazing material to flow to create a solid brazed joint between the cutting tips 10 and the tip pocket 8. Back face 8a and bottom face 8b of tip pocket 8 are disposed at the same sharp angle as bottom face 10f and trailing face 10e of cutting tips 10.

The tip pockets 8 use a relief 20 formed at the theoretical point of intersection of face 8a and face 8b. The relief 20 has a semicircular shape that intersects the faces 8a and 8b to create a recess 22 along the proximate trailing edge of the tip pocket 8. As is shown in FIG. 3 the recess 22 extends into the plate 4 and away from surfaces 8a and 8b. With the relief provided, the proximate trailing edge 12 of tip 8 fits into the recess 22 such that cutting tip bottom face 10f closely abuts tip pocket face 8b and cutting tip trailing face 10e closely abuts tip pocket face 8a as shown in FIG. 2. The abutment of these faces provides structural support for the cutting tips and provides closely abutting surfaces between the cutting tips 10 and tip pocket 8 for the brazing process. While a semi-circular relief is provided it will be understood that any shape relief may be used provide that it can be stamped in high volumes.

With relief 20, the tip pockets 8 are formed by a stamping operation. It is recognized that it is very difficult to stamp sharp comers in high volumes because the cutting edges of the stamping machine will dull over repeated stamping cycles. As a result, comers will not remain sharp in a high volume production and will “round off” through repeated stamping cycles. The “rounding off” of the sharp corner of the tip pocket would cause separation between the faces of the cutting tip and the faces of the tip pocket adversely affecting the brazed connection. Because the seating of the cutting tips 10 on the tip pockets 8 is critical for a good braze and mechanical support of the tips, a stamping operation has not been considered suitable for the high volume, high stress environment of a saw blade. The use of relief 20 eliminates this problem because the sharp intersection between faces 8a and 8b is replaced by the recess 22 such that the cutting tip can be properly seated even if the edges around relief 20 “round off”.

Referring again to FIG. 1, the outer periphery 16 of plate 4 is substantially circular with flat portions 18 formed therein trailing each of the cutting tips 10. The flat portions 18 are basically coextensive with the top face of cutting tips 8 and constitute a cord of the circle defined by outer periphery 16. The flat portions 18 provide clearance for the cutting tips 10 as they move through the material being cut. Outer periphery 16 serves to limit the depth and speed of the cut by limiting the amount of material that can be cut by cutting tips 8 on each revolution of the blade. This is effected by controlling the distance the distal end of the cutting tip 10 extends beyond periphery 16. Thus, the combination of the circular outer periphery and the flat portions 18, allow the blade to move through the cut material but prevent a user from over aggressively cutting the material.

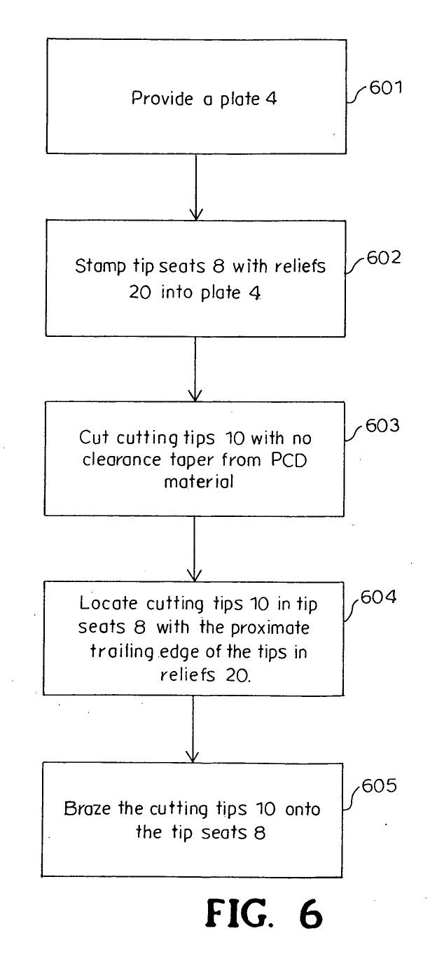

Referring to FIG. 6, in the preferred method of manufacturing the blade of the invention, a plate 4 is provided (block 601). Tip pockets 10 having reliefs 20 as previously described are stamped into plate 4 (block 602). Cutting tips 10 having no clearance taper are cut from the PCD material (block 603). The cutting tips 10 are located in tip pockets 8 such that the proximate trailing edges of the tips are disposed in the recesses 22 defined by reliefs 20 (block 604). In the final step, the tips are brazed onto tip pockets (block 605). The tips are not ground or otherwise given a clearance taper after being formed on tip pockets 8. Because the tip pockets, tips, and the gullet configurations are substantially identical for all of the teeth, the tips are not ground and the tip pocket are stamped into the plate, the cost to manufacture the blade is reduced.

While specific embodiments of the invention are described herein one of ordinary skill in the art will recognize that other embodiments and implementations are possible without departing from the scope of the invention set forth herein.

What is claimed is:

1. A saw blade comprising:
a plurality of teeth disposed about the periphery of a blade having opposed parallel surfaces, each of said plurality of teeth including a cutting tip and a tip pocket;
said plurality of teeth including opposed side faces that are parallel to one another and parallel to the blade surfaces.

2. The saw blade of claim 1, wherein the tip pocket is formed of a back bottom face and a trailing face joined at a recess.

3. The saw blade of claim 1, wherein an edge of the cutting tips is located in the recess.

4. The saw blade of claim 1, wherein the cutting tip extends beyond the blade surfaces.

5. The saw blade of claim 3, wherein the cutting tips are brazed on the tip pockets.

6. The saw blade of claim 1, wherein the periphery of the saw blade has flat surfaces trailing the cutting tips.

7. The saw blade of claim 6, wherein the periphery of the blade other than the flat surfaces is circular.

8. A method of making a saw blade tooth on a saw blade comprising:
stamping a plurality of tip pockets about the periphery of the blade;
providing a plurality of cutting tips, each of said plurality of cutting tips having opposed side faces that are parallel to one another;
securing one of the plurality of cutting tips on one of the plurality of tip pockets to complete the tooth.

9. The method of claim 8 comprising:
stamping the tip pocket with a back bottom face and a trailing face joined and a recess joining the back bottom face and the trailing face.

10. The saw blade of claim 9, locating an edge of the cutting tip in the recess.

11. A method of cutting fiber cement comprising:
providing a saw blade by stamping a plurality of tip pockets about the periphery of the blade;
providing a plurality of cutting tips, each of said plurality of cutting tips having opposed unground side faces that are parallel to one another;
securing one of the plurality of cutting tips on one of the plurality of tip pockets; and
cutting the material with the unground cutting tips.
